(19) United States
(12) Patent Application Publication
(10) Pub. No.: US 2012/0313025 A1
(43) Pub. Date: Dec. 13, 2012

(54) FLUID CONTROL VALVE

(76) Inventors: Katsunori Takai, Tokyo (JP); Masayuki Yokoyama, Tokyo (JP); Satoru Hasegawa, Tokyo (JP)

(21) Appl. No.: 13/581,262

(22) PCT Filed: Jun. 29, 2010
(86) PCT No.: PCT/JP2010/004292

§ 371 Date: Aug. 24, 2012

(51) Int. Cl. F16K 5/00

(52) U.S. Cl. 251/313

(57) ABSTRACT

An actuator unit 10 and a valve unit housing 31 provided with a fluid passage 34 are formed separately, and a water cooling passage 29 is disposed therebetween; components such as a bearing 24, a return spring 28, and a gear 23 that directly couples the actuator unit 10 to a valve shaft 32 are disposed on the side of the actuator unit 10 that is interposed by the water cooling passage 29.

### TECHNICAL FIELD

The present invention relates to a fluid control valve disposed in a pipeline through which a high temperature fluid flows.

### BACKGROUND ART

Conventionally, in a fluid control valve such as an EGRV (Exhaust Gas Recirculation Valve) disposed in a pipeline through which a fluid (especially, a high temperature fluid (up to 800° C.)) flows, due to transferred heat that is transferred from the high temperature fluid to a valve shaft, it is difficult to form an integrated structure in which an output shaft of an actuator unit is meshed directly with the valve shaft with a gear. Therefore, in order to protect components having a low heat resistance temperature such as a substrate and a resin member of the actuator unit, the output shaft of the actuator unit and the valve shaft are often connected with a link, a wire, and so on to be formed as separate configurations, thereby insulating the actuator unit and the valve shaft from each other so that no transferred heat from the valve shaft reaches the actuator unit.

However, as disclosed in Patent Documents 1 and 2, a conventional fluid control valve may employ an integrated structure in which the output shaft of the actuator unit is directly meshed with the valve shaft with a gear. In a fluid control valve of Patent Documents 1 and 2, in order to protect the actuator unit from the transferred heat and radiation heat of a high temperature fluid, different materials are employed for a valve unit housing provided with a fluid passage, and an actuator unit housing (the valve unit housing is made of stainless steel or heat-resistant steel, while the actuator unit housing is made of aluminum), and further engine cooling water is supplied in circulation through the actuator unit housing to be cooled. Otherwise, in order to minimize a contact area between the actuator unit housing and the valve unit housing, an insulating layer of air is provided therebetween, and/or a stainless steel tube is sandwiched between a pipeline and the fluid passage in the valve unit to secure heat resistance thereof. With these configurations, an applicable gas temperature can be raised to 600° C. to 800° C.

### PRIOR ART DOCUMENTS

### Patent Documents

Patent Document 1: Japanese Patent Application Publication No. 2008-196437
Patent Document 2: Japanese Patent Application Publication No. 2007-285311

### SUMMARY OF THE INVENTION

However, as disclosed in Patent Documents 1 and 2, when the diameter of the valve is increased to be applied to a fluid control valve for high flow rate, the thermal amount of the transferred heat and the radiation heat to the actuator unit having an integrated structure with the valve shaft is increased, and therefore heat resistance thereof may be secured insufficiently. Further, in Patent Document 1, since the actuator unit is disposed alongside the valve unit, it is more likely to be affected by the transferred heat and radiation heat having the increased thermal amount. Therefore, there is a problem such that it is difficult to apply a conventional fluid control valve to a fluid control valve through which a fluid is flown at a high flow rate under a high temperature (e.g., up to 800° C.).

The present invention is made to solve the aforementioned problems, and an object of the invention is to provide a fluid control valve that is compatible with a fluid at a high flow rate and at a high temperature.

A fluid control valve according to the present invention includes: an actuator unit for generating a rotation driving force; a housing in which a through hole communicating with a fluid passage provided inside is formed; a valve shaft that is coupled to the actuator unit at one end side and inserted into the fluid passage from the through hole at the other end side, and that is rotated by the rotation driving force of the actuator unit; a valve that rotates integrally with the valve shaft to open and close the fluid passage; a water cooling passage provided between the actuator unit and the housing; and a spring disposed on the side of the actuator unit from the water cooling passage to bias the valve shaft in a direction such that the valve closes the fluid passage.

According to the present invention, the actuator unit and the housing provided internally with the fluid passage are formed separately, and the water cooling passage is disposed therebetween; thus, the actuator unit and a failsafe spring having a low heat resistance temperature can be protected from the transferred heat and radiation heat of the fluid at a high flow rate and at a high temperature, thereby providing a fluid control valve that is compatible with the fluid at a high flow rate and at a high temperature.

### BRIEF DESCRIPTION OF THE DRAWINGS

FIG. 1 is a sectional view showing a configuration of a fluid control valve according to Embodiment 1 of the present invention.

FIG. 2 is a plan view showing a direct link structure of the fluid control valve according to Embodiment 1.

FIG. 3 is a sectional view of a valve unit taken along a line AA in FIG. 1.

FIG. 4 is a sectional view of a water cooling passage taken along a line BB in FIG. 1.

FIG. 5 is a schematic diagram illustrating a cooling effect by water cooling and an effect of the heat from a fluid in the fluid control valve according to Embodiment 1.

### BEST MODE FOR CARRYING OUT THE INVENTION

In the following, to describe the present invention in further detail, embodiments of the present invention will be described with reference to the accompanying drawings.

### Embodiment 1

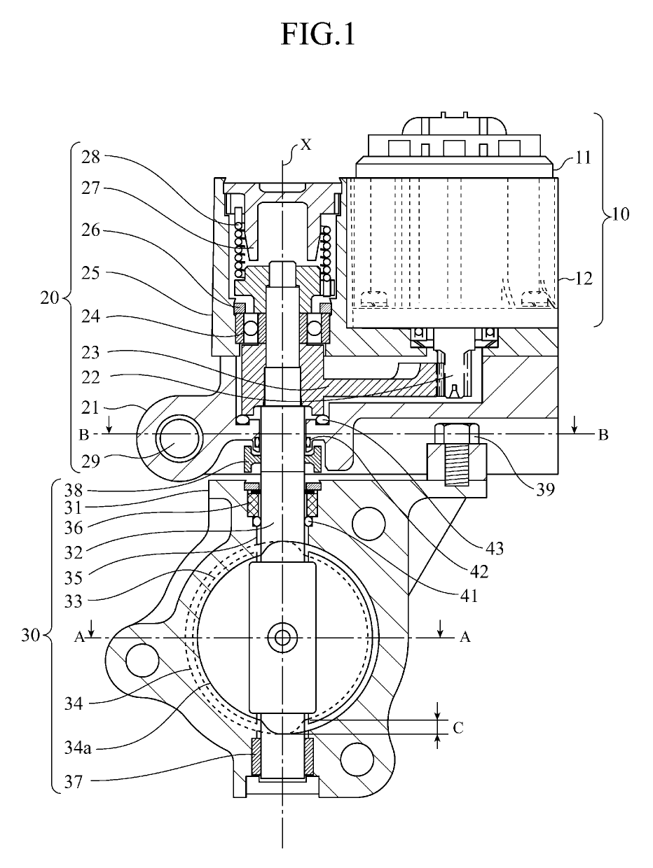

A fluid control valve shown in FIG. 1 is composed of: an actuator unit 10 that generates a rotation driving force for valve opening/closing; a gear unit 20 that transmits the driving force by the actuator unit 10 to a valve shaft 32; and a valve unit 30 that is interposed in a pipe (not shown) through which a fluid such as a high temperature gas flows in order to control a flow rate of the fluid by opening and closing a valve 33.

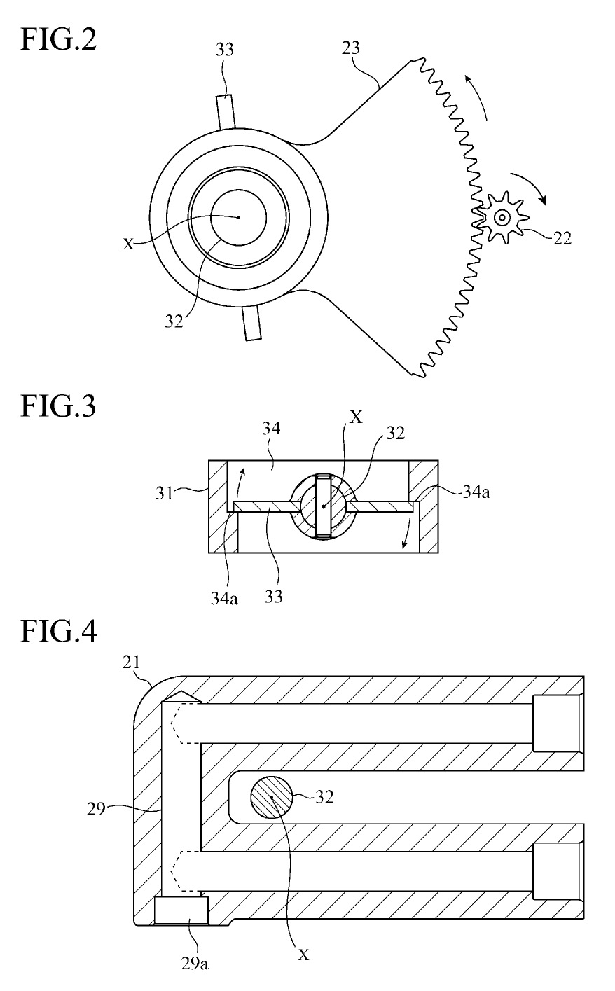

In the actuator unit 10, a DC motor or the like is used as a motor 11, and the motor 11 is surrounded by a heat shield 12. A pinion gear 22 that extends to an interior of a gearbox 21 is formed on one end side of the output shaft of the motor 11. As shown in FIG. 2, when the motor 11 is driven to rotate normally or in reverse, the pinion gear 22 rotates with meshed with a fan-shaped gear 23, so that the driving force of the motor 11 is transmitted directly to the valve shaft 32. In the following, an integrated structure in which the output shaft of the motor 11 is directly coupled to the valve shaft 32 by meshing the pinion gear 22 with the gear 23 will be referred to as a direct link structure. The valve shaft 32 is fixed to the inner ring of a bearing 24 and thus pivotally supported to be rotatable, and is rotated about a rotation center axis X by the driving force of the motor 11 to thus open and close the valve 33 fixed to the valve shaft 32.

With the direct link structure, the pinion gear 22 serving as the output shaft of the motor 11 and the valve shaft 32 are directly coupled by the gear 23, and therefore axial deviation and transmission loss thereof are reduced. In addition, a reduction in the number of components, a cost reduction, and compactness thereof can be achieved. Further, in addition to the compactness of the fluid control valve, there are advantages such that a layout space on the side where the fluid control valve is to be installed can be reduced, and that since the actuator unit 10 and the valve unit 30 are integrated, there is no need to couple the fluid control valve to an external actuator.

A housing of the gear unit 20 is formed by joining the gear box 21 to a gear cover 25, and the heat shield 12 is formed integrally with the gear cover 25. The gear box 21 and the gear cover 25 are formed from aluminum, while the heat shield 12 is formed from aluminum or stainless steel.

The outer ring of the bearing 24 is fixed to an interior of the gear cover 25 such that a bottom surface thereof is fit in a step part on an inner peripheral surface of the gear cover 25 and that a plate 26 is fixedly press-fit therein from top. It is configured that the bearing 24 has a withstand load that is greater than a total load upon application of vibration and application of fluid pressure in the valve unit 30, and that the load applied to the valve unit 30 is supported by the outer ring and inner ring of the bearing 24. In such a way, the backlash in the valve shaft 32 and the valve 33 can be suppressed, and therefore vibration resistance thereof can be secured, enabling a higher flow rate thereof.

Further, a return spring 28 held by a spring holder 27 is disposed on the upper end side of the valve shaft 32 as a failsafe, and the return spring 28 biases the valve shaft 32 to return the valve 33 to a closed position abutting against a valve seat 34a.

The valve unit housing 31 is formed from a heat-resistant steel such as cast iron and stainless steel. A through hole 35 that associates a fluid passage 34 with the outside is provided in the valve unit housing 31. The valve shaft 32 is inserted into the through hole 35. Further, a metallic filter section 36 and a bush 37 are provided around the upper end side and the lower end side of the through hole 35, respectively. One end side of the valve shaft 32 is pivotally supported by the bearing 24, and the other end side is pivotally supported by the bush 37, whereby a both-end-support bearing section is formed. In a cantilever structure such that the valve shaft is pivotally support from one end side as previously discussed in Patent Documents 1 and 2, when a fluid pressure is increased, wrenching is assumed to be more likely to occur in the bearing part of the valve shaft due to an offset load of the valve received from the fluid. Shaft breakage may also occur. On the other hand, with the both-end-support bearing section according to Embodiment 1, wrenching is less likely to occur in the bearing section of the valve shaft 32 and shaft breakage is also less likely to occur; thus, application to a high flow rate thereof can be achieved.

Further, conventionally, a structure in which one end of the valve shaft of the valve unit is connected to the output shaft of the actuator unit by a link is often employed. In this case, even when both ends of the valve shaft are supported, the driving force of the actuator unit is applied only from the one end side connected by the link, and therefore wrenching and shaft breakage are more likely to occur upon reception of an offset load. On the other hand, in Embodiment 1, both ends of the valve shaft 32 are supported by the both-end-support structure, and the direct link structure is connected between both end supports thereof, that is, in a halfway point of the valve shaft 32; thus, the driving force of the actuator unit 10 can be transmitted easily to each of the bearing sections on both ends thereof, leading to a lessened degree of the offset load received by both the ends. Thus, wrenching and shaft breakage thereof are less likely to occur. Moreover, when one of the bearing/bushing sections in the both-end-support bearing structure is provided by the bearing 24, the place between the valve shaft 32 and the bearing can be supported by a ball bearing, and therefore sliding thereof is produced more easily, as compared with a slide bearing such that the place between the bearing and the valve shaft 32 is supported by a sliding surface, so that wrenching thereof is less likely to occur.

Further, the valve unit 30 is constructed by a step type butterfly valve. Specifically, as shown in FIG. 3, the valve seat 34a is formed by providing a step in the fluid passage 34. The circular valve 33 is attached to the other valve shaft 32; the valve 33 rotates about the rotation center axis X integrally with the valve shaft 32 to change the amount of clearance between the valve 33 and the valve seat 34a, thereby controlling the flow rate of the fluid. When the valve is closed, a seal is formed such that the valve seats 34a abut against the front surface of a semicircle on one side of the valve 33 and the rear surface of a semicircle on the other side thereof.

In this structure, when a part of the valve shaft 32 fixed by the bearing 24 forms a starting point at a high temperature, the valve shaft 32 is thermally expanded in the direction of the bush 37, and thereby a positional deviation occurs in the valve 33. As long as the positional deviation is small enough to be contained in a step C of the valve seat 34a, no positional deviation of the valve 33 interferes with the fluid passage 34 even after the positional deviation, and no leakage occurs between the valve 33 and the valve seat 34a. In this way, when a length of the step C is set appropriately in the step type valve structure, the effect of the positional deviation in the valve 33 due to a thermal expansion of the valve shaft 32 can be canceled.

As shown in FIG. 4, a water cooling passage 29 is formed in the gear box 21. The water cooling passage 29 is disposed at a halfway point of the valve shaft 32 among the valve unit 30, actuator unit 10, and gear unit 20. In the illustrated example, one of three openings formed in the water cooling passage 29 is closed by a plug 29a to form a C-shaped passage, while one of the remaining openings serves as an inlet and the other thereof serves as an outlet.

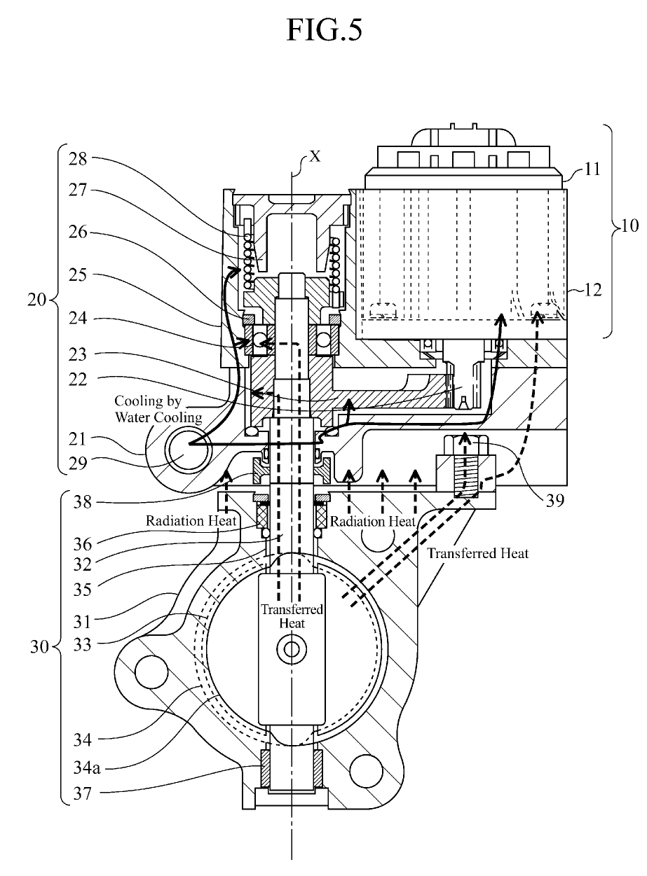

FIG. 5 is a schematic diagram illustrating the cooling effect (arrows indicated by solid lines) by the water cooling passage 29 and the effect (arrows indicated by dotted lines) of the heat from the high temperature fluid flowing through the fluid passage 34. The water cooling effect of the water cooling passage 29 is enhanced when the gear box 21 and the gear cover 25 is formed from aluminum, and thereby components such as the valve shaft 32, bearing 24, and return spring 28 are cooled efficiently. A water cooling effect of the heat shield 12 (aluminum or stainless steel) formed integrally with the water cooling passage 29 can also be enhanced, and therefore the actuator unit 10 can be cooled efficiently.

Further, the gear 23 is disposed between the valve unit 30 and the bearing 24, and therefore the heat traveling the valve shaft 32 is absorbed by the gear 23 to suppress the heat transfer to the bearing 24, thereby protecting the bearing 24. Moreover, since the return spring 28 is disposed in a position apart from the valve unit 30 and heat is absorbed by the gear 23, the heat transfer to the return spring 28 is suppressed.

Furthermore, the valve unit housing 31 and the gear box 21 are fixed by a bolt 39. As shown in FIG. 1, the valve unit housing 31 is out of contact with the gear box 21 other than the fixing part of the bolt 39, and a gap is provided therebetween; thus, the radiation heat from the valve unit 30 can be blocked. Moreover, even if the radiation heat from the valve unit 30 is received, it is configured that the heat passes through the gear box 21 and the gear cover 25, and therefore the heat transfer to the actuator unit 10 can be suppressed.

In such a way, the effects of the transferred heat and the radiation heat transmitted from the valve unit 30 to the actuator unit 10 and the gear unit 20 are reduced, and heat resistance can be secured in the components such as the motor 11, gear 23, bearing 24, and return spring 28 to be compatible with a fluid at a high flow rate and at a high temperature.

Furthermore, a cover 38 is disposed on the valve shaft 32 between the valve unit housing 31 and the gear box 21 to ensure that no fluid flowing through the fluid passage 34 travels on the surface of the valve shaft 32 and escapes or intrudes into the gear box 21. In this manner, a labyrinth structure by the cover 38 is formed in the vicinity of an opening in the gear box 21 into which the valve shaft 32 is inserted, and therefore not only the fluid (exhaust gas) but also water and foreign matter through the gap between the valve unit housing 31 and the gear box 21 from the outside are less likely to intrude the gear box 21.

In order to prevent perfectly the water and foreign matter from intruding into the gear box 21, shaft seals 41, 42 may be disposed in the gap between the gear box 21 and the valve shaft 32, in addition to the cover 38, and further a shaft seal 43 may be disposed in the gap between the gear box 21 and the gear 23.

Incidentally, when a further increase in the flow rate is required, it can be handled by larger diameters of the fluid passage 34 and the valve 33. Since the larger diameter of the valve 33 increases the load received from the fluid, the bearing section may be reinforced as required such that the number of bearings 24 for pivotally supporting the valve shaft 32 is increased and/or that the bush 37 is elongated to increase a contact area thereof with the valve shaft 32.

As described above, according to Embodiment 1, the fluid control valve is configured to include: the actuator unit 10 for generating the rotation driving force; the valve unit housing 31 in which the through hole 35 communicating with the fluid passage 34 provided inside is formed; the valve shaft 32 that is coupled to the actuator unit 10 at one end side and inserted into the fluid passage 34 from the through hole at the other end side, and that is rotated by the rotation driving force of the actuator unit 10; the valve 33 that rotates integrally with the valve shaft 32 to open and close the fluid passage 34; the water cooling passage 29 provided between the actuator unit 10 and the valve unit housing 31; and the return spring 28 disposed on the side of the actuator unit 10 from the water cooling passage 29 to bias the valve shaft 32 in a direction such that the valve 33 closes the fluid passage 34. For this reason, the actuator unit 10 and the failsafe return spring 28, both of which have a low heat resistance temperature, can be protected from the transferred heat and radiation heat of the fluid at a high flow rate and at a high temperature to be flown through the valve unit 30. It is therefore possible to provide a fluid control valve that is compatible with the fluid at a high flow rate and at a high temperature.

Further, according to Embodiment 1, it is configured that the fluid control valve also includes the bearing sections with a both-end-support structure in which one is disposed on the side of the actuator unit 10 from the water cooling passage 29 and pivotally supports the one end side of the valve shaft 32, and which the other pivotally supports the other end side of the valve shaft 32 with the valve 33 interposed therebetween. For this reason, wrenching and shaft breakage thereof are less likely to occur, and durability thereof to the load of the fluid at the high flow rate is enhanced.

Furthermore, it is configured that one of the bearing/bushing sections with the both-end-support structure is constituted by the bearing 24 that is disposed on the side of the actuator unit 10 from the water cooling passage 29 to pivotally support the one end side of the valve shaft 32, and therefore the bearing 24 can be protected from the transferred heat and radiation heat of the fluid at a high flow rate and at a high temperature. Moreover, the valve shaft 32 can slide more smoothly, and therefore wrenching is less likely to occur.

Further, according to Embodiment 1, it is configured that the fluid control valve includes: the pinion gear 22 that is formed integrally with the actuator unit 10 to be rotationally driven; and the gear 23 that is disposed on the side of the actuator unit 10 from the water cooling passage 29 and formed integrally with the valve shaft 32 to mesh with the pinion gear 22. In this way, the gear 23 is cooled by the water cooling passage 29, and therefore the heat transfer from the valve shaft 32 to the actuator unit 10 is blocked, so that the actuator unit 10 can be protected. Therefore, the pinion gear 22 serving as the output shaft of the actuator unit 10, and the valve shaft 32 can be coupled directly by the gear 23, which enables a reduction in the number of component, a cost reduction and a compactness thereof. Also, the axial deviation and transmission loss thereof are lessened.

Furthermore, when the gear 23 is formed integrally with the valve shaft 32 in a section sandwiched between the bearing sections with the both-end-support structure, the driving force of the actuator unit 10 is transmitted easily to both ends of the valve shaft 32; thus, the degree of the offset load received on both ends thereof is reduced, so that wrenching and shaft breakage thereof are less likely to occur.

Further, according to Embodiment 1, the fluid control valve is configured such that the heat shield 12 surrounding the actuator unit 10 is formed integrally with the gear cover 25 provided with the water cooling passage 29, and therefore, the actuator unit 10 can be cooled efficiently to be thereby protected from the transferred heat and radiation heat of the fluid.

Incidentally, described in the above Embodiment 1 is an instance in which the fluid control valve is applied to the fluid at a high flow rate and at a high temperature; however, it goes without saying that the valve is applicable likewise to a fluid at a low flow rate and at a low temperature.

Further, the output shaft of the actuator unit 10 is coupled to the valve shaft 32 using the direct link structure, but the present invention is not limited to thereto, and the output shaft of the actuator unit 10 may be coupled to the valve shaft 32 directly. Likewise in this instance, the heat from the valve unit 30 is shielded by the gearbox 21 and the gear cover 25 that are cooled by the water cooling passage 29 and the actuator unit 10 is surrounded by the heat shield 12, and therefore the actuator unit 10 can be protected from the heat. The other components such as the bearing 24 and the return spring 28 that require cooling are also disposed on the side of the actuator unit 10 from the water cooling passage 29 to thus secure heat resistance thereof.

### INDUSTRIAL APPLICABILITY

As described above, the fluid control valve according to the present invention is compatible with the fluid at a high flow rate and at a high temperature, and is therefore suitable for use as an exhaust gas recirculation valve and so on.

1-6. (canceled)

7. A fluid control valve comprising:
an actuator unit for generating a rotation driving force;
a housing in which a through hole communicating with a fluid passage provided inside is formed;
a valve shaft that is coupled to the actuator unit at one end side and inserted into the fluid passage from the through hole at the other end side, and that is rotated by the rotation driving force of the actuator unit;
a valve that rotates integrally with the valve shaft to open and close the fluid passage;
a water cooling passage provided between the actuator unit and the housing;
a spring disposed on the side of the actuator unit from the water cooling passage to bias the valve shaft in a direction such that the valve closes the fluid passage; and
bearing sections with a both-end-support structure in which one is disposed on the actuator unit side from the water cooling passage and pivotally supports the one end side of the valve shaft, and which the other pivotally supports the other end side of the valve shaft with the valve interposed therebetween,
wherein one of the bearing sections with the both-end-support structure is constituted by a bearing that is disposed on the actuator unit side from the water cooling passage to pivotally support the one end side of the valve shaft, and
wherein a load applied to a valve unit is supported by an outer ring and an inner ring of the bearing to have a withstand load that is greater than a total load upon application of vibration and application of fluid pressure of the valve unit.

8. The fluid control valve according to claim 7, further comprising:
a pinion gear formed integrally with the actuator unit to be rotationally driven; and
a gear disposed on the actuator unit side from the water cooling passage and formed integrally with the valve shaft to mesh with the pinion gear.

9. The fluid control valve according to claim 7, further comprising:
a pinion gear formed integrally with the actuator unit to be rotationally driven; and
a gear disposed on the actuator unit side from the water cooling passage and formed integrally with a part of the valve shaft sandwiched between the bearing sections of the both-end-support structure to mesh with the pinion gear.

10. The fluid control valve according to claim 7, wherein a heat shield that surrounds the actuator unit is formed integrally with the water cooling passage.
